(19) United States
(12) Patent Application Publication
(10) Pub. No.: US 2007/0277118 A1
(43) Pub. Date: Nov. 29, 2007

(54) Providing suggestion lists for phonetic input

(75) Inventors: Krishna V. Kotipalli, Issaquah, WA (US); Bhrighu Sareen, Redmond (CA)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/439,563

(22) Filed: May 23, 2006

(51) Int. Cl. G06F 3/048

(52) U.S. Cl. 715/780

(57) ABSTRACT

Various technologies and techniques are disclosed for providing suggestion lists for phonetic input. The system receives user input in a source language from an input device. The input is a partial phonetic representation in the source language of a character desired by a user in a destination language. Based on the user's input, a suggestion list is generated that includes a set of key/character combinations that can be pressed/entered on an input device in the source language to achieve at least one resulting character in the destination language. The suggestion list is dynamically generated based upon a prior usage history of the user. The suggestion list is displayed to the user on a display. The user can customize various suggestion list display settings. Upon generating the suggestion list, the display settings are retrieved, and the suggestion list is formatted according to the display settings.

### BACKGROUND

Given the fact that there are dozens if not hundreds of different Indic language dialects, hardware manufacturers selling to such customers standardize in making computer keyboards in a second language commonly known by customers across dialects, which in many cases is an English keyboard. This either requires the customer to know English fluently in order to type on the English keyboard, or that they use some software program that allows them to somehow select characters in a local dialect in a tedious fashion, such as by selecting the characters from a symbol list from an on-screen keyboard or from a physical keyboard which has the local language characters. The input problem in such languages is compounded by the fact that multiple characters are usually associated with a single character, and the case of the character often determines the character that will be ultimately obtained. Other types of languages suffer from similar input problems.

### SUMMARY

Various technologies and techniques are disclosed for providing suggestion lists for phonetic input. The system receives user input from an input device in a source language. The input is a partial phonetic representation in the source language (such as English) of a character desired by a user in a destination language (such as an Indic language). Based on the user's input, a suggestion list is generated that includes a set of key/character combinations that can be pressed/entered using the input device in the source language to achieve at least one resulting character in the destination language. The suggestion list is dynamically generated based upon a prior usage history of the user. The suggestion list is displayed to the user on a display. The user can customize various suggestion list display settings, such as orientation, selection method, and display style. Upon generating the suggestion list, the display settings are retrieved, and the suggestion list is formatted according to the display settings.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a phonetic input application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in generating a suggestion list based on a prediction.

FIG. 5 is a process flow diagram for one implementation of the system of FIG. 1 illustrating the stages involved in generating a suggestion list based on a training goal.

FIG. 6 is a process flow diagram for one implementation of the system of FIG. 1 illustrating the stages involved in generating a suggestion list based on timing.

FIG. 7 is a process flow diagram for one implementation of the system of FIG. 1 that illustrates the stages involved in generating a suggestion list of what else could sound the same in the destination language.

FIG. 8 is a process flow diagram for one implementation of the system of FIG. 1 that illustrates the stages involved in allowing a user to customize various suggestion list options.

FIG. 9 is a diagram for one implementation of the system of FIG. 1 that illustrates a simulated suggestion list based on lower case input with English as a source language and Telugu as a destination language.

FIG. 10 is a diagram for one implementation of the system of FIG. 1 that illustrates a simulated suggestion list based on lower case input with English as a source language and Hindi as a destination language.

FIG. 11 is a diagram for one implementation of the system of FIG. 1 that illustrates a simulated suggestion list based on upper case input with English as a source language and Telugu as a destination language.

FIG. 12 is a diagram for one implementation of the system of FIG. 1 that illustrates a simulated suggestion list based on upper case input with English as a source language and Hindi as a destination language.

FIG. 13 is a diagram for one implementation of the system of FIG. 1 that illustrates a simulated suggestion list that includes phonetic matches and sounds-like matches.

FIG. 14 is a simulated screen for one implementation of the system of FIG. 1 that illustrates a vertically oriented suggestion list to aid the user in inputting characters into a program in a destination language based on input in a source language.

FIG. 15 is a simulated screen for one implementation of the system of FIG. 1 that illustrates a language bar to use for selecting a language to use for phonetic input.

FIG. 16 is a simulated screen for one implementation of the system of FIG. 1 that illustrates selecting a destination language.

FIG. 17 is a simulated screen for one implementation of the system of FIG. 1 that illustrates a horizontally oriented suggestion list to aid the user in inputting characters into a program in a destination language based on input in a source language.

FIG. 18 is a simulated screen for one implementation of the system of FIG. 1 that illustrates a selectable suggestion list to aid the user in inputting characters into a program in a destination language based at least in part on selections from the suggestion list.

FIG. 19 is a simulated screen for one implementation of the system of FIG. 1 that illustrates a transparent suggestion list that allows a user to see contents present behind the suggestion list.

FIG. 20 is a simulated screen for one implementation of the system of FIG. 1 that illustrates displaying a suggestion list when the user inputs a handwritten character using a pen input device.

FIG. 21 is a simulated screen for one implementation of the system of FIG. 1 that illustrates displaying a suggestion list when the user is working in an email application.

FIG. 22 is a simulated screen for one implementation of the system of FIG. 1 that illustrates allowing a user to customize suggestion list display options.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a phonetic input application, but the system also serves other purposes in addition to these. In one implementation, one or more of the techniques described herein can be implemented as features within a word processing program such as MICROSOFT® Office Word, MICROSOFT® Office Excel, Corel WordPerfect, or from any other type of program or service that allows a user to input data. In another implementation, one or more of the techniques described herein are implemented as features with other applications that deal with user input.

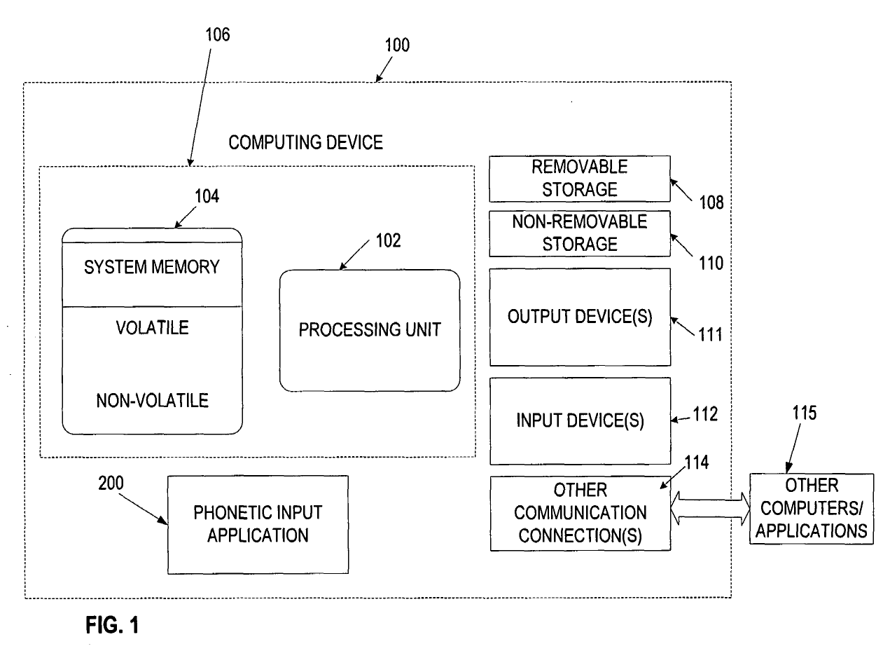

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

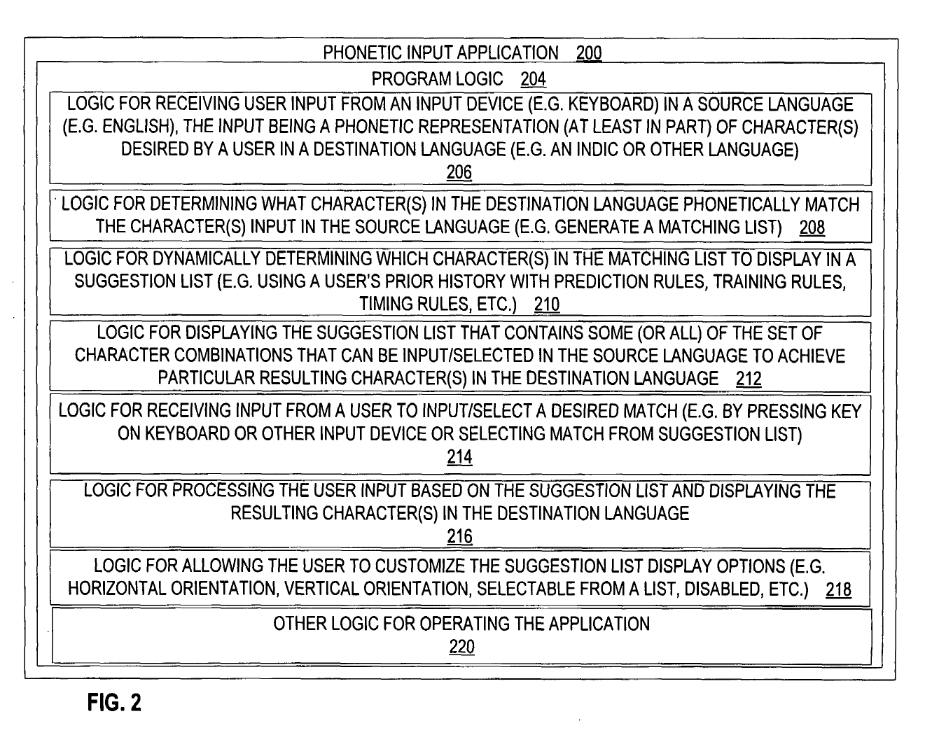

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes phonetic input application 200. Phonetic input application 200 will be described in further detail in FIG. 2.

Turning now to FIG. 2 with continued reference to FIG. 1, a phonetic input application 200 operating on computing device 100 is illustrated. Phonetic input application 200 is one of the application programs that reside on computing device 100. However, it will be understood that phonetic input application 200 can alternatively or additionally be embodied as computer-executable instructions on one or more computers and/or in different variations than shown on FIG. 1. Alternatively or additionally, one or more parts of phonetic input application 200 can be part of system memory 104, on other computers and/or applications 115, or other such variations as would occur to one in the computer software art.

Phonetic input application 200 includes program logic 204, which is responsible for carrying out some or all of the techniques described herein. Program logic 204 includes logic for receiving user input from an input device (e.g. keyboard, pen, etc.) in a source language (e.g. English), the input being a phonetic representation (at least in part) of character(s) desired by a user in a destination language (e.g. an Indic or other language) 206; logic for determining what character(s) in the destination language phonetically match the character(s) input in the source language (e.g. generate a matching list) 208; logic for dynamically determining which character(s) in the matching list to display in a suggestion list (e.g. based on user's prior history with prediction rules, training rules, timing rules, etc.) 210; logic for displaying the suggestion list that contains some (or all) of the combinations that can be input/selected to achieve particular resulting character(s) in the destination language 212; logic for receiving input from a user to input/select a desired match (e.g. by pressing/entering a key/character on a keyboard or other input device or selecting a match from suggestion list) 214; logic for processing the user input based on the suggestion list and displaying the resulting character(s) in the destination language 216; logic for allowing the user to customize the suggestion list display options (e.g. horizontal orientation, vertical orientation, selectable from a list, disabled, etc.) 218; and other logic for operating the application 220. In one implementation, program logic 204 is operable to be called programmatically from another program, such as using a single call to a procedure in program logic 204.

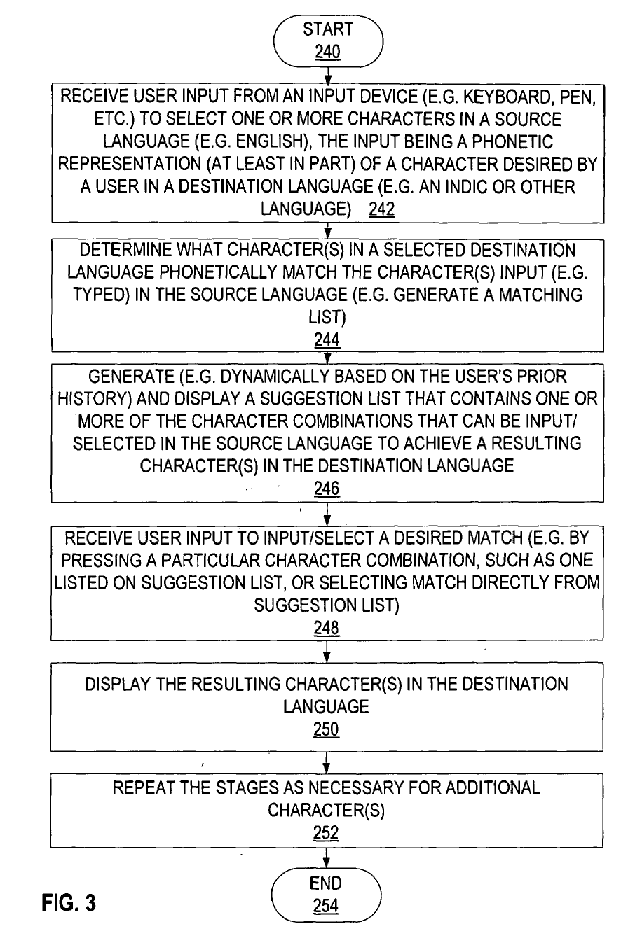

Turning now to FIGS. 3-8 with continued reference to FIGS. 1-2, the stages for implementing one or more implementations of phonetic input application 200 are described in further detail. FIG. 3 is a high level process flow diagram for phonetic input application 200. In one form, the process of FIG. 3 is at least partially implemented in the operating logic of computing device 100. The procedure begins at start point 240 with receiving user input from an input device (e.g. keyboard, pen, etc.) to select one or more characters in a source language (e.g. English) (stage 242). The input is a phonetic representation (at least in part) of one or more characters desired by a user in a destination language, such as Indic or another language (stage 242). The system determines what characters(s) in a selected destination language phonetically match the character(s) input (e.g. typed) in the source language (e.g. generates a matching list) (stage 244). The system generates a suggestion list, such as dynamically based on the user's prior history (stage 246). The suggestion list is displayed that contains one or more of the character combinations that can be input/selected in the source language to achieve the resulting character(s) in the destination language (stage 246). The system receives user input to input/select a desired match (e.g. by pressing character combination from suggestion list or selecting match directly from suggestion list) (stage 248). The system displays the resulting character(s) in the destination language on a display (stage 250). The stages are repeated as necessary for additional characters (stage 252). The process ends at end point 254.

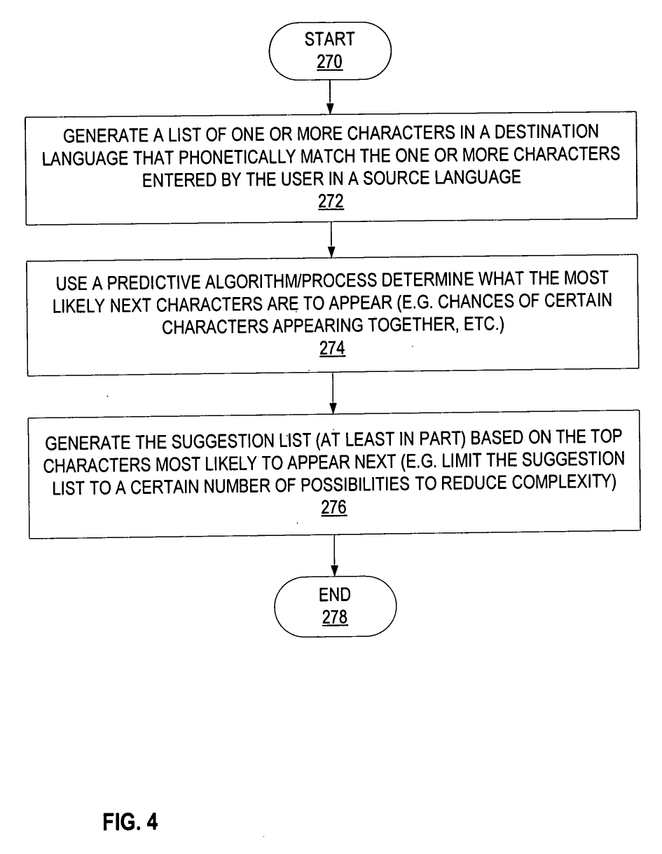

FIG. 4 illustrates one implementation of the stages involved in generating a suggestion list based on a prediction. In one form, the process of FIG. 4 is at least partially implemented in the operating logic of computing device 100. The procedure begins at start point 270 with generating a list of one or more characters in a destination language that phonetically match (at least in part) the one or more characters entered by the user in a source language (stage 272). The system uses a predictive algorithm/process to determine what the most likely next characters are to appear (e.g. chances of certain characters appearing together, etc.) (stage 274). The suggestion list is then generated (at least in part) based on the top characters most likely to appear next (stage 276). In other words, the suggestion list is limited to a certain number of possibilities to reduce complexity (stage 276). The process ends at end point 278.

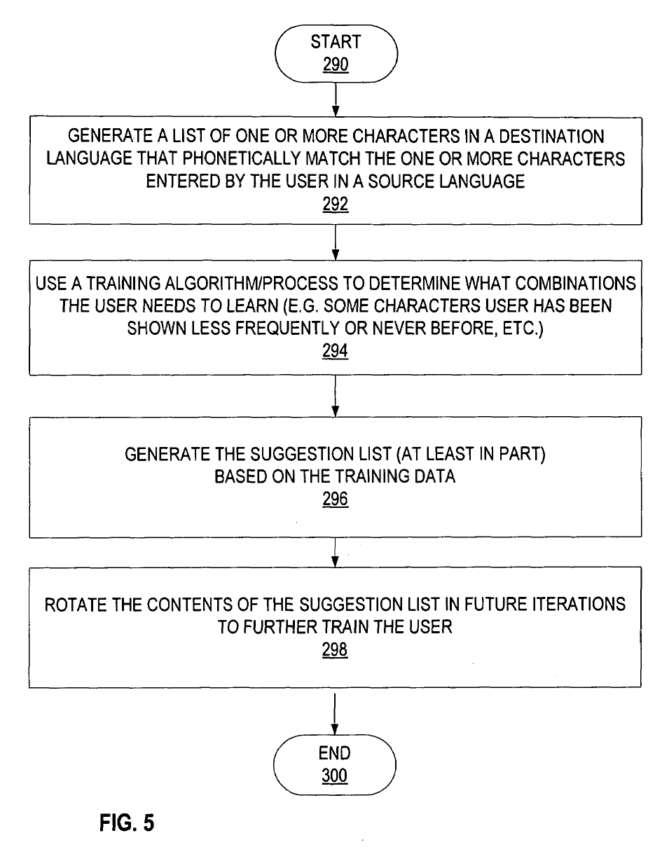

FIG. 5 illustrates one implementation of the stages involved in generating a suggestion list based on a training goal. In one form, the process of FIG. 5 is at least partially implemented in the operating logic of computing device 100. The procedure begins at start point 290 with generating a list of one or more characters in a destination language that phonetically match the one or more characters entered by the user in a source language (stage 292). The system uses a training algorithm/process to determine what combinations of characters the user needs to learn (e.g. some characters user has been shown less frequently or never before, etc.) (stage 294). A suggestion list is generated (at least in part) based on the training data (stage 296). The contents of the suggestion list are rotated in future iterations to further train the user (stage 298). The process ends at end point 300.

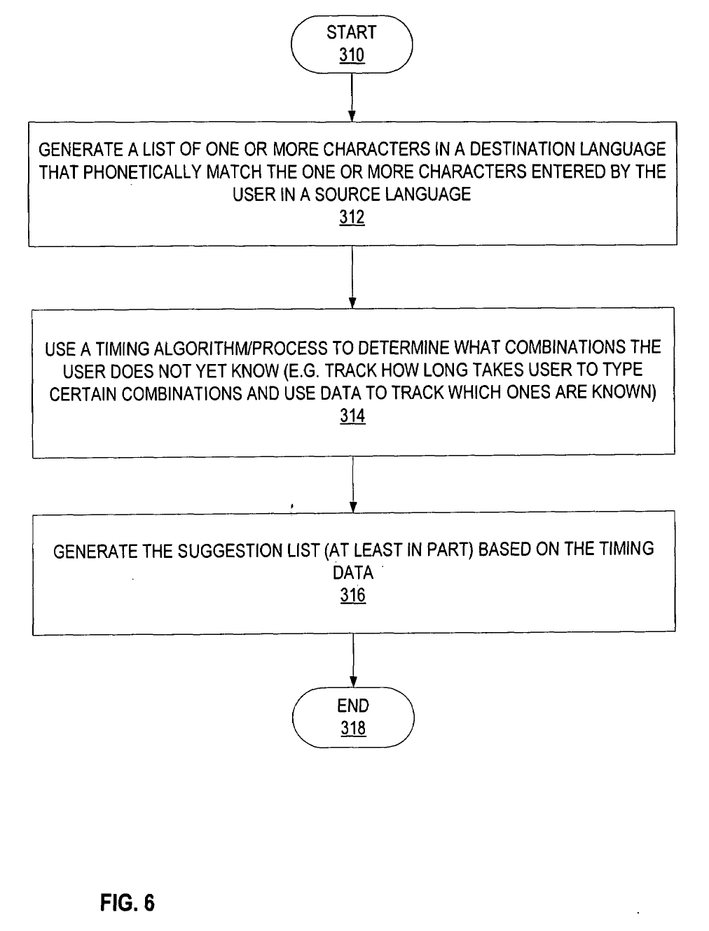

FIG. 6 illustrates one implementation of the stages involved in generating a suggestion list based on timing. In one form, the process of FIG. 6 is at least partially implemented in the operating logic of computing device 100. The procedure begins at start point 310 with generating a list of one or more characters in a destination language that phonetically match the one or more characters entered by the user in a source language (stage 312). The system uses a timing algorithm/process to determine what combinations the user does not yet know (e.g. tracks how long it takes the user to type certain combinations and uses the data to track which character combinations are known) (stage 314). A suggestion list is generated (at least in part) based on the timing data (stage 316). The process ends at end point 318.

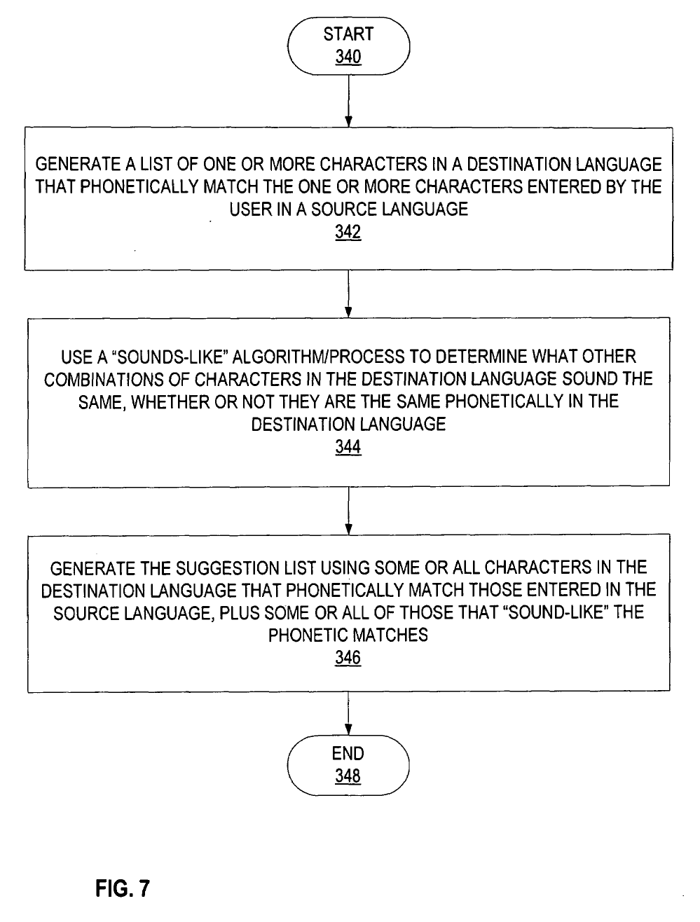

FIG. 7 illustrates one implementation of the stages involved in generating a suggestion list that includes other characters that could sound the same in the destination language. In one form, the process of FIG. 7 is at least partially implemented in the operating logic of computing device 100. The procedure begins at start point 340 with generating a list of one or more characters in a destination language that phonetically match the one or more characters entered by the user in a source language (stage 342). The system uses a “sound-like”algorithm/process to determine what other combinations of characters in the destination language sound the same, whether or not they are the same phonetically in the destination language (stage 344). The suggestion list is generated using some or all characters in the destination language the phonetically match those entered in the source language, plus some or all of those that “sound-like” the phonetic matches (stage 346). The process ends at end point 348.

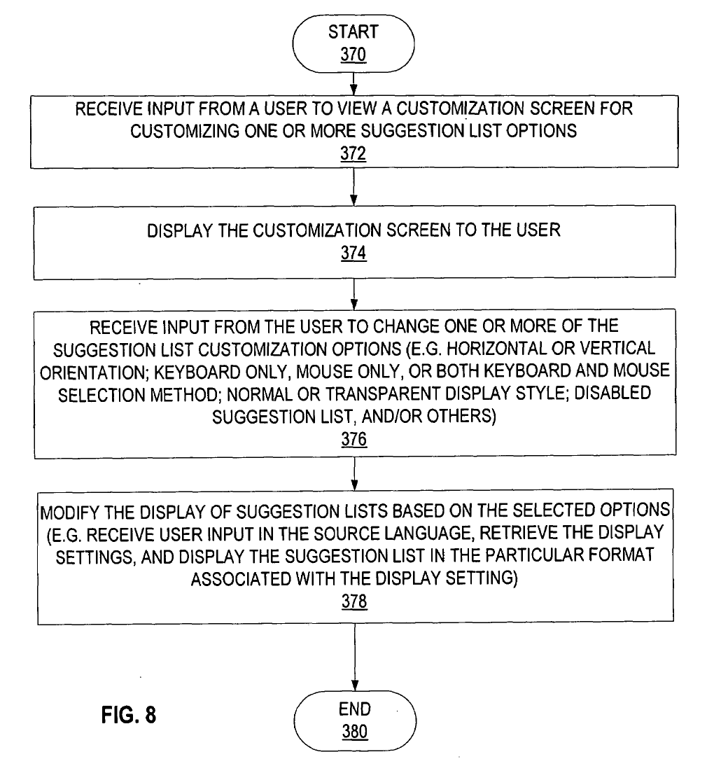

FIG. 8 illustrates one implementation of the stages involved in allowing a user to customize various suggestion list options. In one form, the process of FIG. 8 is at least partially implemented in the operating logic of computing device 100. The procedure begins at start point 370 with receiving input from a user to view a customization screen for customizing one or more suggestion list options (stage 372). The customization screen is displayed to the user (stage 374). The system receives input from the user to change one or more of the suggestion list customization options (e.g. orientation, selection method, display style, disabled, and/or others) (stage 376). The display of future suggestion lists is modified based on the selection display options (stage 378). In other words, the system receives user input in the source language, retrieves the display settings, and displays the suggestion list in the particular format associated with the one or more display settings (stage 378). The process ends at end point 380.

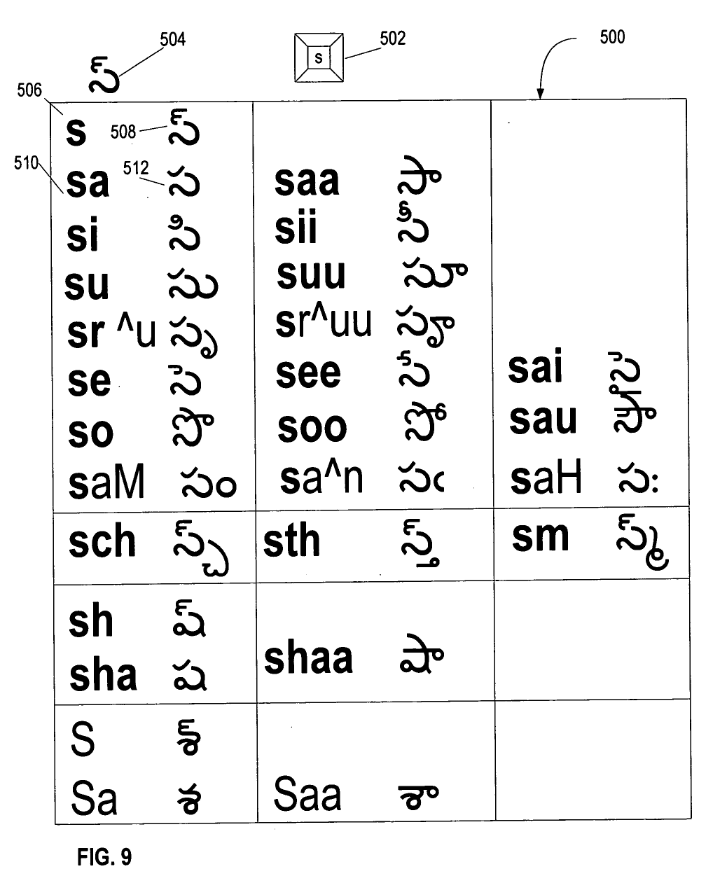

FIG. 9 is a diagram for one implementation of the system of FIG. 1 that illustrates a simulated suggestion list 500 based on lower case input with English as a source language and Telugu as a destination language. Upon pressing/entering the lower case “s” key 502 on a keyboard or other input device, suggestion list 500 is displayed to show various character combinations that can be pressed to achieve a desired character in the Telugu language. For example, without pressing a further character beyond the “s” 502, the character 504 will result because it is the matching character 508 in the suggestion list 500 for “s” 506. If the user further selects the letter “a” on an input device, then the “sa” combination 510 will result in character 512 being displayed.

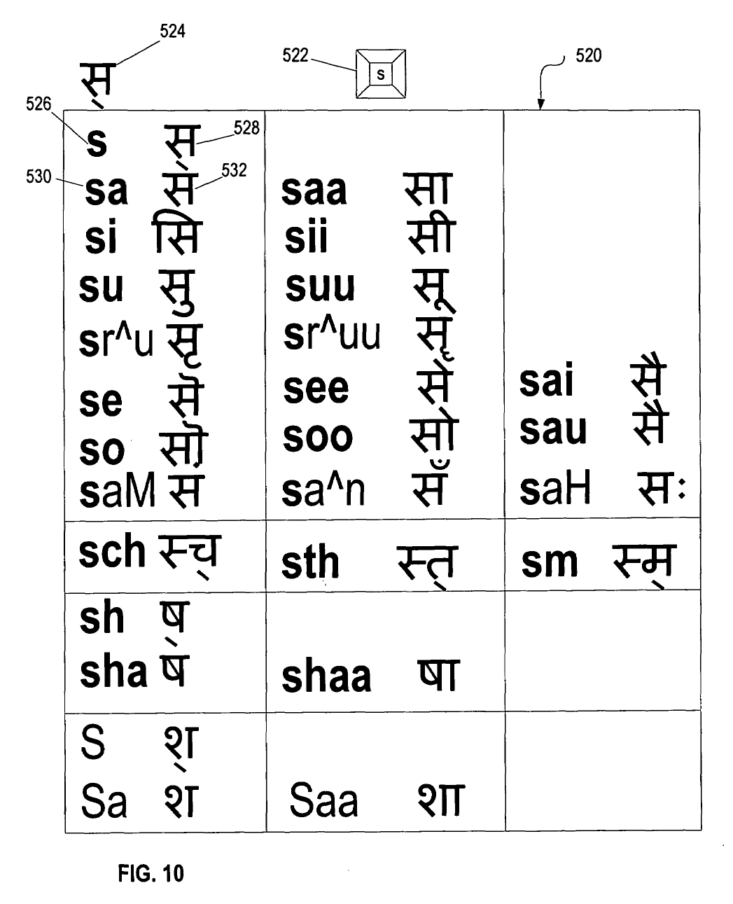

FIG. 10 is a diagram for one implementation of the system of FIG. 1 that illustrates a simulated suggestion list 520 based on lower case input with English as a source language and Hindi as a destination language. Upon pressing/entering the lower case “s” key 522 on a keyboard or other input device, suggestion list 520 is displayed to show various character combinations that can be pressed to achieve a desired character in the Hindi language. For example, without pressing a further character beyond the “s” 522, the character 524 will result because it is the matching character 528 in the suggestion list 520 for “s” 526. If the user further selects the letter “a” on an input device, then the “sa” combination 530 will result in character 532 being displayed.

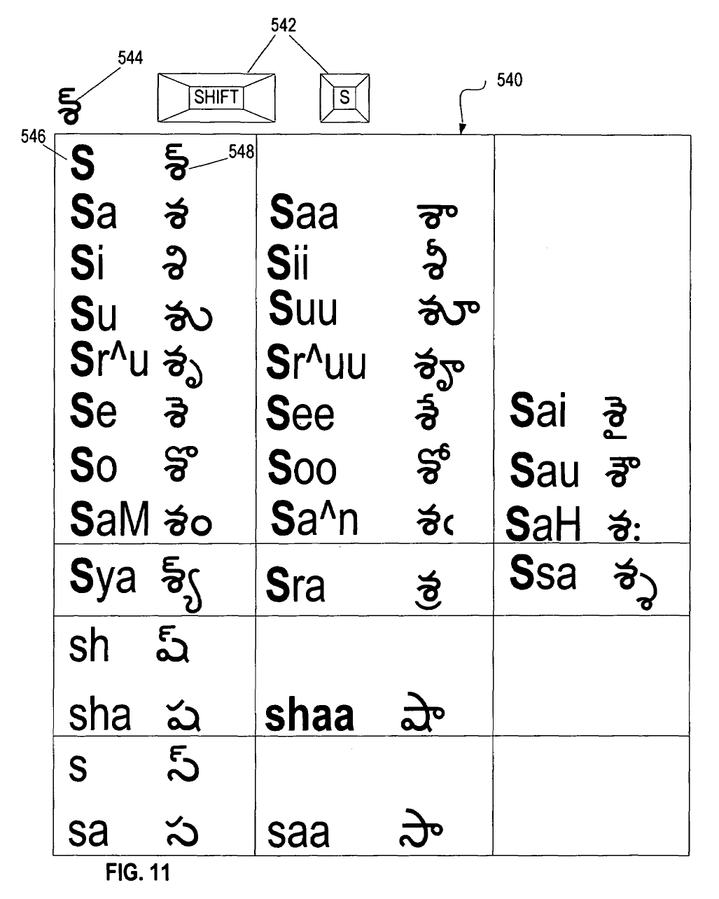

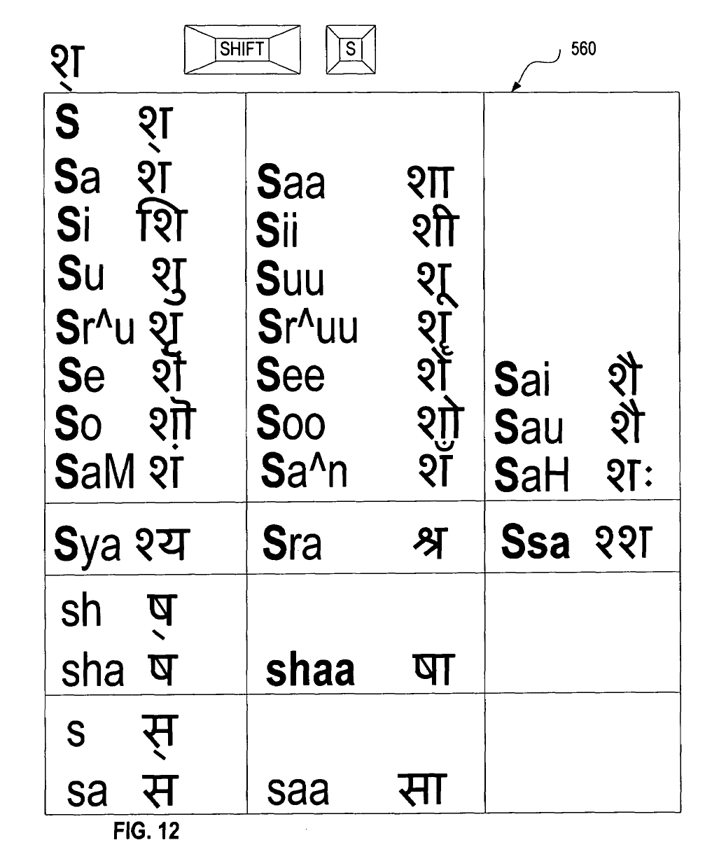

As mentioned previously, in Indic and other languages, a different set of characters is often associated with upper case characters than lower case characters. FIG. 11 is a diagram for one implementation of the system of FIG. 1 that illustrates a simulated suggestion list 540 based on upper case input with English as a source language and Telugu as a destination language. Upon pressing/entering the “shift”+“s” keys 542 in combination on a keyboard or other input device, suggestion list 540 is displayed based on the upper case input to show various character combinations that can be pressed to achieve a desired character. Since an upper case “S” was generated, character 544 is displayed because it matches the Telugu character entry 548 in the suggestion list for upper case “S” 546. Similarly, FIG. 12 illustrates a simulated suggestion list 560 based on upper case input with English as a source language and Hindi as a destination language.

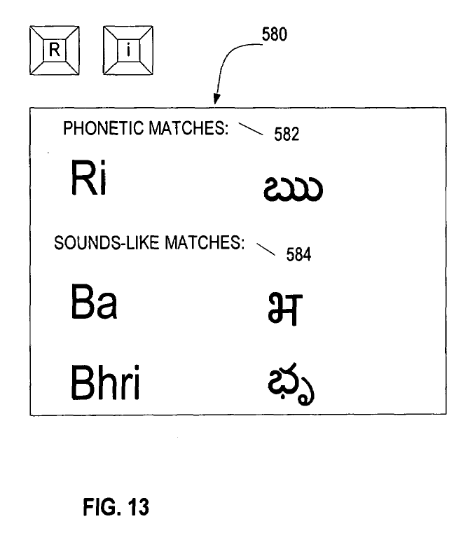

FIG. 13 is a diagram for one implementation of the system of FIG. 1 that illustrates a simulated suggestion list that includes phonetic matches and sounds-like matches. As described in the stages of FIG. 7, in one implementation, the system uses a “sounds-like” algorithm/process to determine what additional combinations of characters in the destination language “sound” the same, even though they are different phonetically (stage 344). The system then includes some of these “sounds-like” matches 584 in the suggestion list 580 in addition to the normal phonetic matches 582 (stage 346).

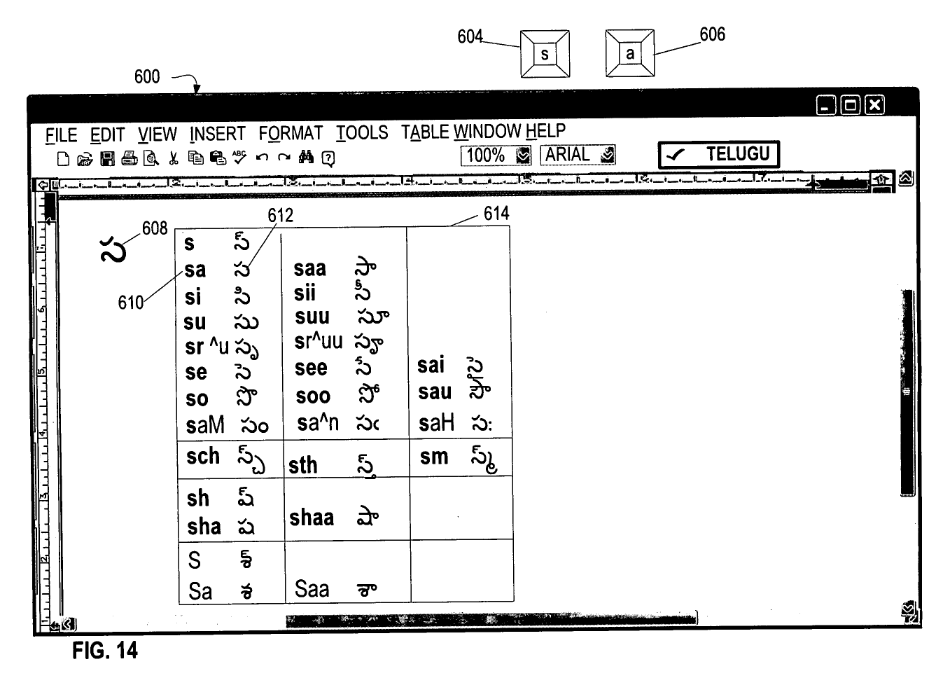

FIG. 14 is a simulated screen 600 for one implementation of the system of FIG. 1 that illustrates a vertically oriented suggestion list 614 to aid the user in inputting characters into a program in a destination language 602 based on input in a source language. In the example shown, characters “s” 604 and “a” 606 were entered in English using an input device, and the resulting character 608 was displayed in the program because it was the character 612 that matched “sa” 610 in the suggestion list 614.

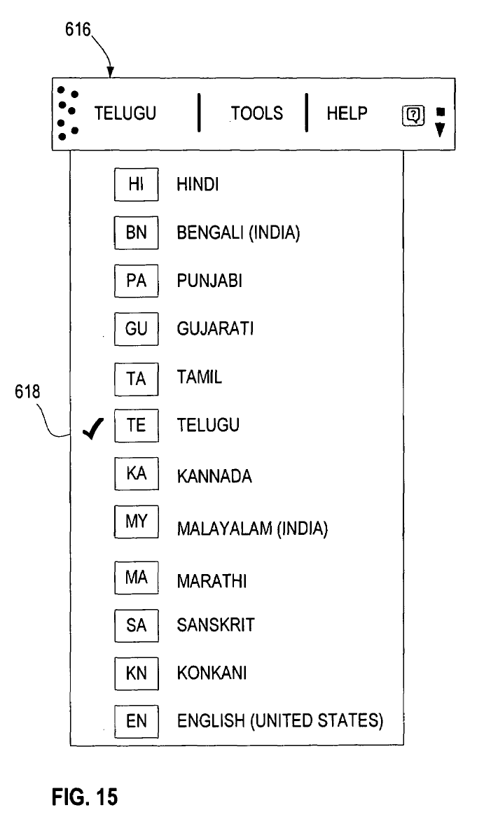

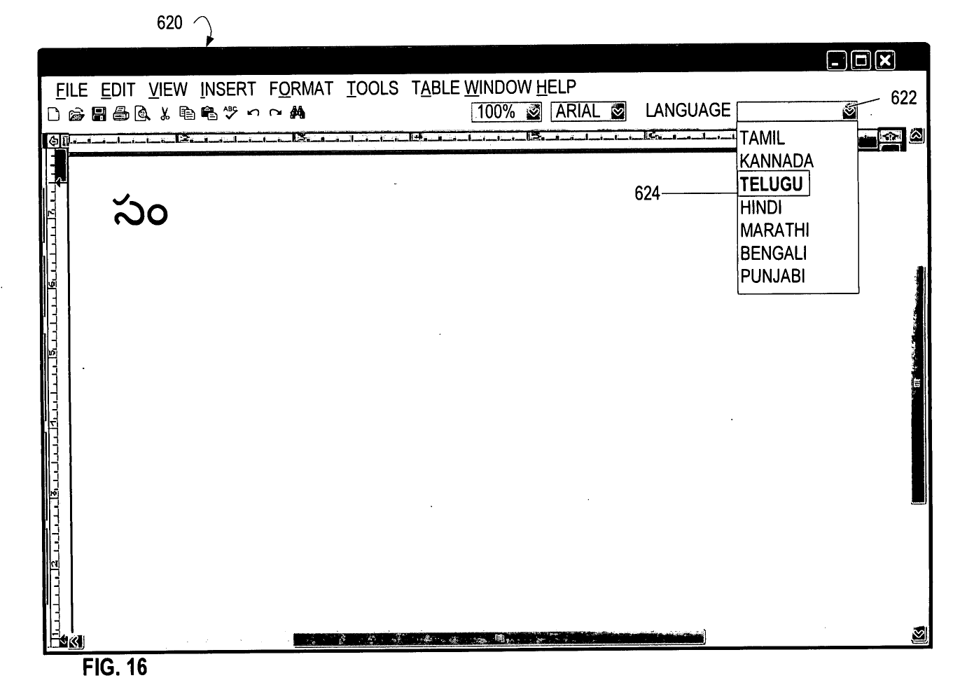

FIG. 15 is a simulated screen for one implementation of the system of FIG. 1 that illustrates a language bar 616 to use for selecting a language to use for phonetic input. The currently selected language 618 is shown with a check box, which in this example is Telugu. In one implementation, the language bar 616 is used to set a desired language for use with all applications in an operating system. In another implementation, the language bar is specific to one or more particular applications. FIG. 16 is a simulated screen 620 for another implementation of the system of FIG. 1 that illustrates selecting a destination language from within a particular application. Upon selecting a language option from list 622, the user can select the destination language to display the resulting data in, such as Telugu 624.

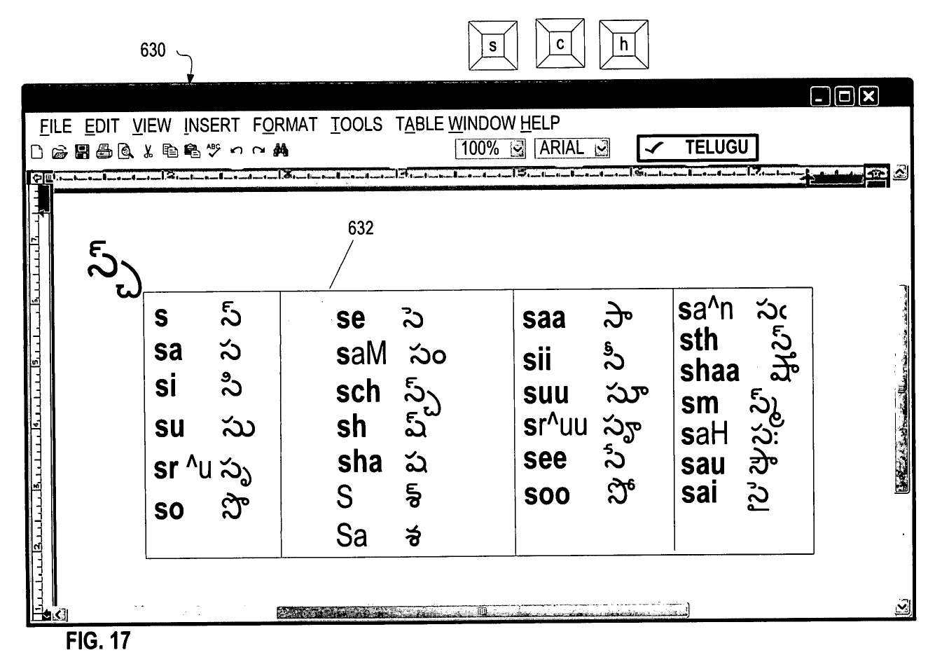

Similar to FIG. 14, FIG. 17 is a simulated screen 630 for one implementation of the system of FIG. 1 that illustrates a horizontally oriented suggestion list 632 to aid the user in inputting characters into a program in a destination language based on input in a source language. The screen 630 is said to be horizontally oriented because it expands more horizontally than it does vertically. Numerous other horizontal and/or vertical orientations for suggestion list 632 could also be used.

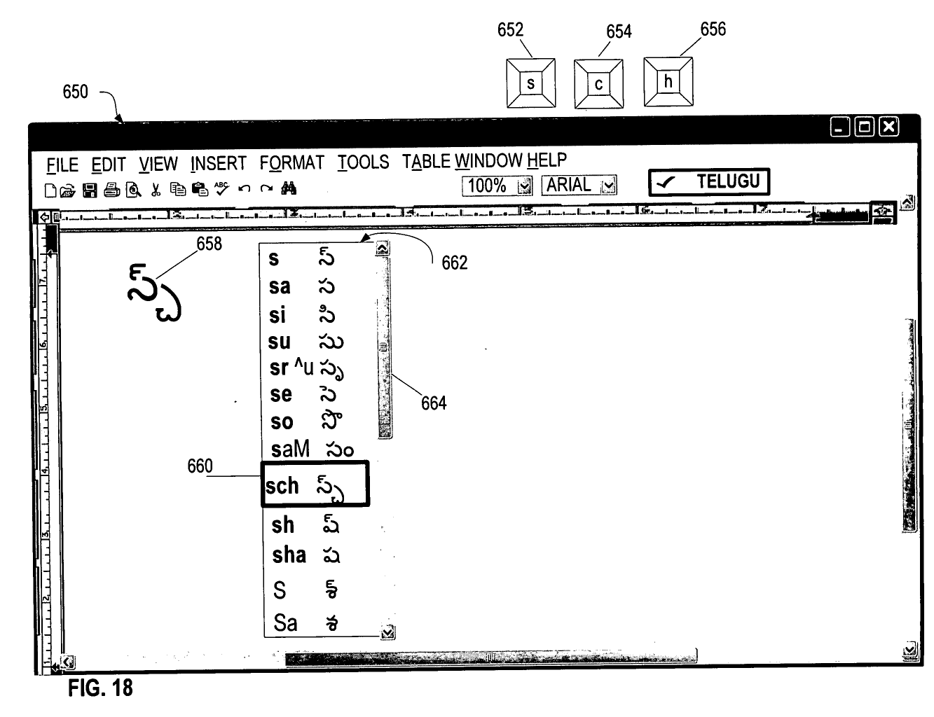

FIG. 18 is a simulated screen 650 for one implementation of the system of FIG. 1 that illustrates a selectable suggestion list 662 to aid the user in inputting characters into a program in a destination language based at least in part on selections from the suggestion list. In one implementation, as the user selects characters using an input device (such as characters “s” 652, “c” 654, and “h” 656), the matching value 660 is shown selected in the suggestion list 662. Alternatively or additionally, the user can select a desired match directly from the list 662 without having to further type characters. A scroll bar 664 allows the user to scroll down to view additional matching characters.

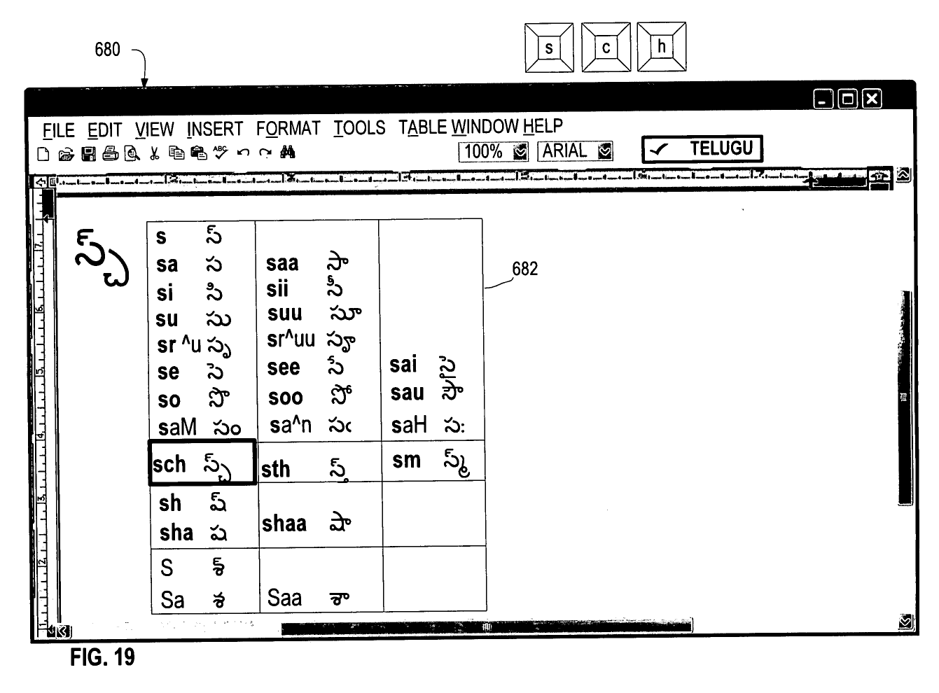

FIG. 19 is a simulated screen 680 for one implementation of the system of FIG. 1 that illustrates a transparent suggestion list 682 that allows a user to see contents present behind the suggestion list.

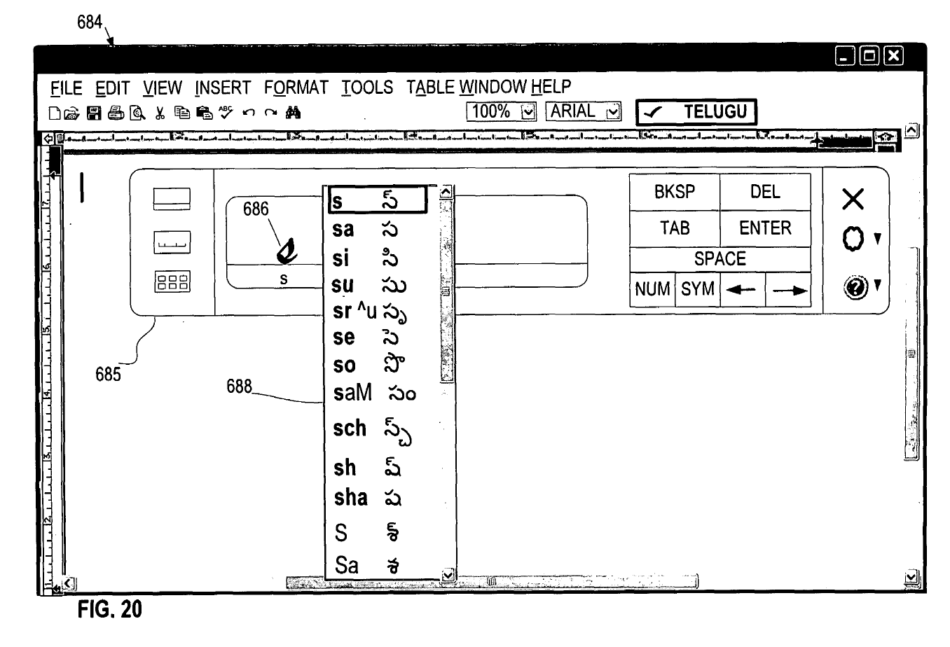

FIG. 20 is a simulated screen 684 for one implementation of the system of FIG. 1 that illustrates displaying a suggestion list when the user inputs a handwritten character using a pen input device. In the example shown, the user has entered a cursive “s” 686 in a pen input panel 685, and suggestion list 688 is shown to provide the user further guidance on possible phonetic options.

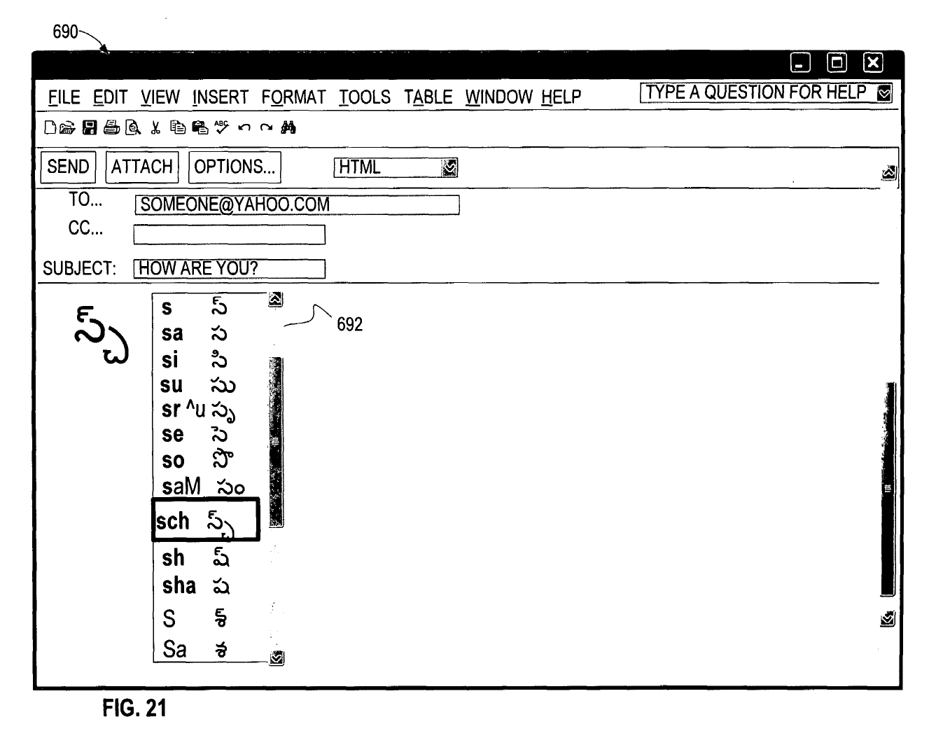

FIG. 21 is a simulated screen 690 for one implementation of the system of FIG. 1 that illustrates displaying a suggestion list 692 when the user is working in an email application.

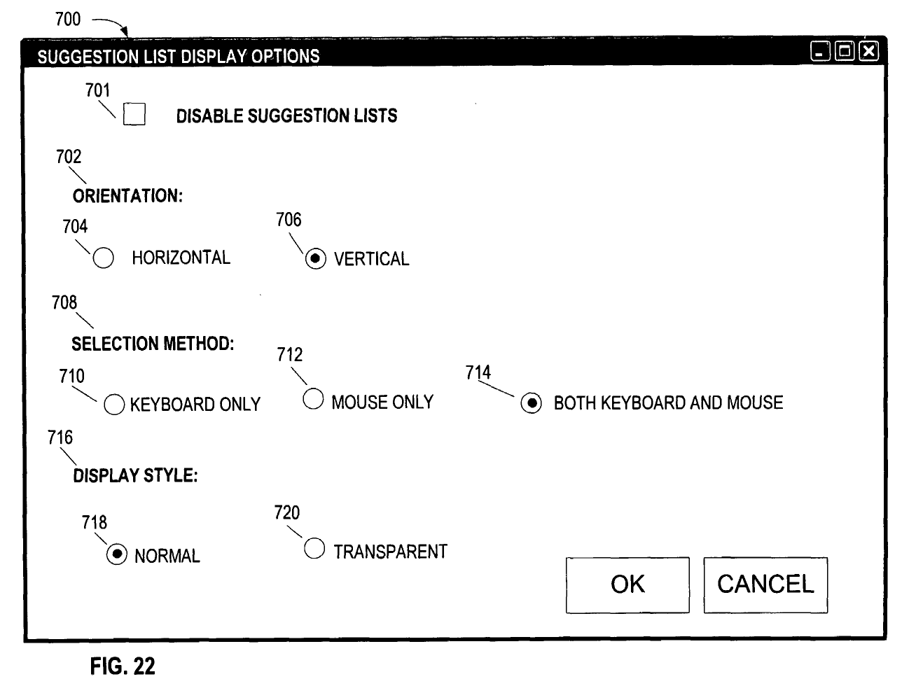

FIG. 22 is a simulated screen 700 for one implementation of the system of FIG. 1 that illustrates allowing a user to customize suggestion list display options. As described in the stages of FIG. 8, the user can customize the suggestion list display options in one implementation. Suggestion list display options screen 700 is a non-limiting example of the type of customization screen that could be used for such customizations. The user can check “disable suggestion lists” option 701 when he/she no longer desires to see the suggestion lists. The orientation option 702 can be set to horizontal 704, vertical 706, or others as provided. The selection method option 708 can be set to keyboard only 710, mouse only 712, or both keyboard and mouse 714, or others as provided. The display style option 716 can be set to normal 718, transparent 720, or others as desired. These are non-limiting examples of the types of suggestion list display options that could be used to allow the user to customize the user experience with suggestion lists for phonetic input. It will be appreciated that numerous other types of options could also be provided.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for providing a suggestion list for phonetic input comprising the steps of:
receiving a first input in a source language from an input device, the first input being at least a partial phonetic representation in the source language of a character desired by a user in a destination language;
based upon the first input, generating a first suggestion list that includes a first set of character combinations that can be entered using the input device in the source language to achieve at least one resulting character in the destination language; and
displaying the first suggestion list on a display.

2. The method of claim 1, further comprising:
receiving a second input from the input device in the source language, the second input being the same as the first input.

3. The method of claim 2, further comprising:
based upon the second input and a prior history with the user, generating a second suggestion list that is different from the first suggestion list in at least some fashion based on the prior history of the user.

4. The method of claim 3, wherein the prior history with the user is used to generate the second suggestion list with contents that include a second set of character combinations the user is not already familiar with.

5. The method of claim 3, wherein the prior history with the user is used to generate the second suggestion list so the user is not shown a same set of character combinations frequently.

6. The method of claim 1, wherein the first set of character combinations in the first suggestion list represents only a portion of an available set of character combinations that phonetically match the first input.

7. The method of claim 6, wherein only the portion of the available set of character combinations are represented in the first suggestion list so a number of choices presented to the user is reduced.

8. The method of claim 1, wherein the first suggestion list is predictive and based upon what the user has previously typed.

9. A computer-readable medium having computer-executable instructions for causing a computer to perform the steps recited in claim 1.

10. A computer-readable medium having computer-executable instructions for causing a computer to perform steps comprising:
receive input in a source language from an input device, the input being at least a partial phonetic representation in the source language of a character desired by a user in a destination language; and
based upon the input, generate a suggestion list that includes a set of character combinations that can be entered in the source language using the input device to achieve at least one resulting character in the destination language, the suggestion list being dynamically generated based upon a prior usage history of the user, and the set of character combinations phonetically matching at least part of the input in the source language.

11. The computer-readable medium of claim 10, further operable to cause a computer to perform the step comprising:
display the suggestion list on a display.

12. The computer-readable medium of claim 11, wherein the suggestion list is operable to be displayed in a horizontal fashion on the display.

13. The computer-readable medium of claim 11, wherein the suggestion list is operable to be displayed in a vertical fashion on the display.

14. The computer-readable medium of claim 10, wherein the suggestion list is operable to allow the user to select a desired match from the suggestion list.

15. The computer-readable medium of claim 10, wherein the suggestion list is operable to be disabled by the user.

16. A method for displaying a suggestion list for phonetic input comprising the steps of:
receiving input in a source language from an input device, the input being at least a partial phonetic representation in the source language of a character desired by a user in a destination language;
retrieving at least one suggestion list display setting;
displaying a suggestion list in a particular format associated with the display setting, the format including a set of character combinations that can be entered using the input device in the source language to achieve at least one resulting character in the destination language; and
wherein the set of character combinations phonetically match at least part of the input in the source language.

17. The method of claim 16, wherein the at least one suggestion list display setting is selected from the group consisting of a horizontal orientation and a vertical orientation.

18. The method of claim 16, wherein the at least one suggestion list display setting is selected from the group consisting of a keyboard only selection method, a mouse only selection method, and a both keyboard and mouse selection method.

19. The method of claim 16, wherein the at least one suggestion list display setting is selected from the group consisting of a normal display style and a transparent display style.

20. A computer-readable medium having computer-executable instructions for causing a computer to perform the steps recited in claim 16.
